(19) United States
(12) Patent Application Publication
(10) Pub. No.: US 2010/0075183 A1
(43) Pub. Date: Mar. 25, 2010

(54) SYSTEM AND METHOD OF DELIVERING HYDROGEN IN A VEHICLE

(75) Inventors: Terry A. Johnson, Livermore, CA (US); Daniel E. Dedrick, Oakland, CA (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/545,280

(22) Filed: Aug. 21, 2009

Related U.S. Application Data
(60) Provisional application No. 61/098,351, filed on Sep. 19, 2008.

(51) Int. Cl. H01M 8/00; H01M 2/00

(52) U.S. Cl. 429/13; 429/34

(57) ABSTRACT

One exemplary embodiment includes a modular hydrogen storage system including discrete modules constructed and arranged so the hydrogen can be delivered from a discrete module independent of the rest of the system.

### CROSS-REFERENCE TO RELATED APPLICATIONS

This application claims the benefit of U.S. Provisional Application No. 61/098,351 filed Sep. 19, 2008.

### TECHNICAL FIELD

The field to which the disclosure generally relates to includes systems and methods of delivering hydrogen in a vehicle.

### BACKGROUND

Heretofore hydrogen has been delivered from a hydrogen storage vessel to a fuel cell for generating electricity used to propel a vehicle. A typical hydrogen storage vessel is shown in FIG. 1.

### SUMMARY OF EXEMPLARY EMBODIMENTS OF THE INVENTION

One exemplary embodiment includes a modular hydrogen storage system including discrete modules constructed and arranged so the hydrogen can be delivered from a discrete module independent of the rest of the system.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 illustrates a prior art hydrogen storage vessel.

FIG. 2 illustrates a modular hydrogen storage system according to one exemplary embodiment.

FIG. 3 is a graph of comparative simulation results.

### DETAILED DESCRIPTION OF EXEMPLARY EMBODIMENTS

The following description of the embodiment(s) is merely exemplary (illustrative) in nature and is in no way intended to limit the invention, its application, or uses.

One exemplary embodiment includes a modular hydrogen storage system where discrete modules enable hydrogen to be desorbed independently from the rest of the system. During desorption, if only a portion of the system is required for operation, only that segment is heated, thus requiring less parasitic energy. This can also be important for start-up. If the system is initially cold, a single module can be rapidly heated to the operating temperature required to deliver hydrogen. Of even greater importance to energy efficiency is that only the modules that have hydrogen left in them are heated while empty modules would be allowed to cool until refueling. This could be especially important when a vehicle uses a full tank over many days because continually heating spent storage media that does not produce hydrogen is wasted energy. Additionally, if certain portions of the system are reacting at different rates (due to composition, temperature, etc.) the capabilities of each bed can be coordinated to provide the appropriate flow for the immediate system demands. This could minimize overall system temperature and heat usage as well as insure maximum hydrogen flow rate when the storage system is nearly empty.

Certain embodiments may provide for an overall increase in storage system energy density as compared to a system that doesn't use a smart delivery control strategy. In other words, for the same useful hydrogen storage capacity, a system using this control strategy would be smaller and lighter than a system not controlled this way. The increase in energy density is due to three enabling aspects: efficiency in thermal management that reduces the parasitic heating loss for hydrogen delivery, increased hydrogen flow rate capability over the total capacity of the storage system, and rapid start-up.

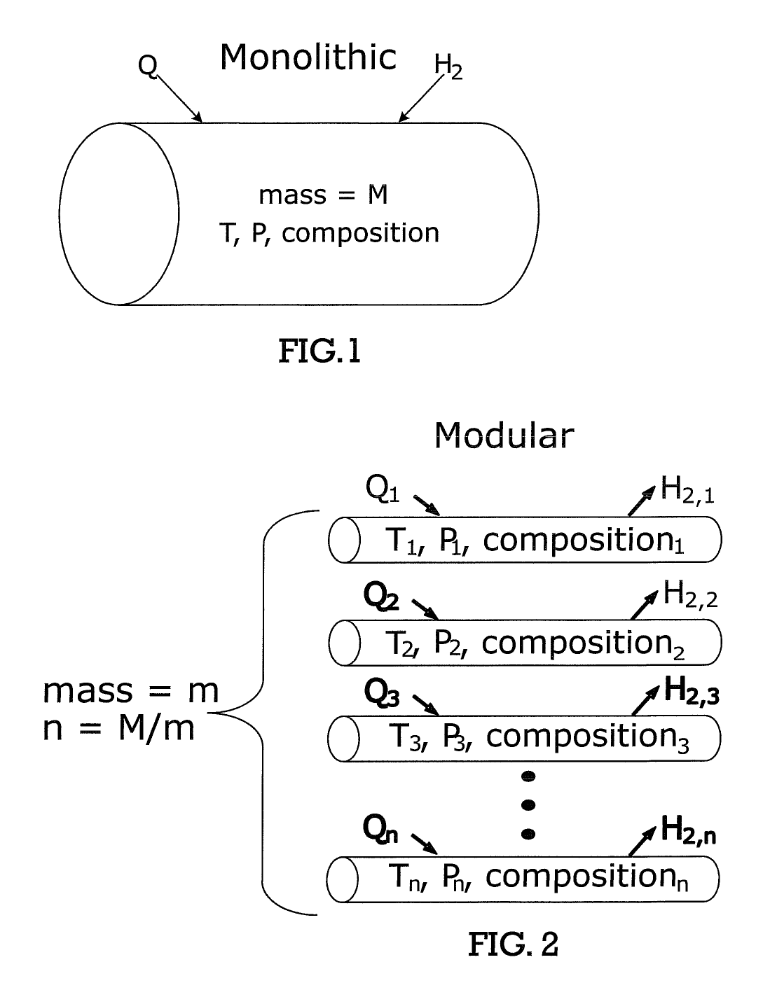

Various exemplary embodiment may include metal hydride systems, adsorbant systems such as those based on metal organic frameworks, or chemical hydride systems. One embodiment may include a modular storage system design and a ‘smart’ control strategy for hydrogen delivery to the vehicle power plant. FIG. 2 illustrates some of the differences between a modular storage system and a monolithic storage system (FIG. 1). The monolithic system (FIG. 1) consists of the storage media stored in a single large vessel. During operation the storage media is at a single temperature T, pressure P, and composition. In contrast, the modular system contains the same amount of storage media M, but it is distributed to n smaller vessels where n may be, for example, 10 to 20. Each of these smaller vessels will have its own temperature Tₙ, pressure Pₙ, and composition that can be individually controlled by heat input and hydrogen desorption rate. One exemplary embodiment may include three or more storage modules that are controlled in a coordinated fashion during hydrogen delivery. The exact number of modules will depend on the thermodynamics and chemical kinetics of the storage media, the exact delivery control strategy, and the vehicle size.

An overall increase in storage system energy density may be achieved with a modular system compared to a system with a monolithic hydrogen storage tank. The increase in energy density is due to three enabling aspects: efficiency in thermal management that reduces the parasitic heating loss for hydrogen delivery, increased hydrogen flow rate capability over the total capacity of the storage system, and rapid start-up.

Beyond this primary benefit enabled by the ‘smart’ delivery control logic, a modular storage system has other attributes listed below that would make it an attractive design for automotive applications. (1) Contamination: Hydrogen storage media can be contaminated if exposed to the ambient environment due to a rupture in the storage vessel. For example, metal hydrides can be contaminated by air and moisture. If a module is damaged contamination would be limited to just a fraction of the entire system. (2) Maintenance/repair: If damaged or contaminated, a single module could be replaced rather than replacing the entire storage tank. (3) Conformability: Multiple small modules could conform to an odd shape or could be distributed throughout the vehicle. (4) Safety: The amount of hydrogen released and hazardous material exposed could be minimized in an accident if only one or several modules were damaged. (5) Fuel gage: With 10-20 modules, empty modules could be counted for fuel level indication. (6) Variable size: Modularity allows for a variable storage system size from a single module design. For instance, 10 modules might be used for a sedan while 15 modules could be used for a large SUV.

To explore the primary benefit of this design let's first consider the heat of reaction (ΔH). This is heat that must be supplied to the storage media for it to release its stored hydrogen. For example, most relevant complex hydrides have heats of reaction on the order of 40 kJ/mol H2. This means that a complex hydride storage system requires 20 kW of heat during desorption for a 1 g/sec hydrogen flow rate. Other storage media may have lower heats of reaction, but as long as the release of hydrogen is endothermic this heat must be taken into account.

Additionally, the storage media may only release hydrogen at temperatures in excess of the typical 80 C operating temperature of a PEM fuel cell. For example, all known complex hydrides operate at temperatures significantly greater than 80 C. Adsorbants typically store hydrogen at cryogenic temperature, but may still need to be heated to release all of the stored hydrogen. Chemical systems vary in release temperature, but may also require a temperature increase for full hydrogen release. So, the heat of reaction plus the heat required to bring and maintain the system at an elevated temperature will be an additional parasitic load on the hydrogen storage/fuel cell system, and must be taken into account when determining the energy density of a hydrogen storage system. In other words, stored hydrogen that must be used for heating instead of delivered to the power plant can not be counted in the system energy density.

In a modular hydrogen storage system where discrete modules enable hydrogen to be desorbed independently from the rest of the system. During desorption, if only a portion of the system is required for operation, only that segment is heated, thus requiring less parasitic energy. During start-up. if the system is initially cold, a single module can be rapidly heated to the operating temperature required to deliver hydrogen. Of even greater importance to energy efficiency is that only the modules that have hydrogen left in them are heated while empty modules would be allowed to cool until refueling. This could be especially important when a vehicle uses a full tank over many days because continually heating spent storage media that does not produce hydrogen is wasted energy. Additionally, if certain portions of the system are reacting at different rates (due to composition, temperature, etc.) the capabilities of each bed can be coordinated to provide the appropriate flow for the immediate system demands. This could minimize overall system temperature and heat usage as well as insure maximum hydrogen flow rate when the storage system is nearly empty.

Simulations were performed using a combined fuel cell/hydrogen storage system dynamic model. The point of the analysis was to determine the difference in overall fuel efficiency of the fuel cell/hydrogen storage system by using a modular bed configuration with smart desorption control versus a monolithic system. In order to perform the analysis some assumptions were made about the storage media, storage system configuration, fuel cell performance, driving conditions, etc. Those assumptions are listed below:

### Smart Bed

Multiple modules (˜10)
Heat input to each module is individually controlled
Up to three modules used at a time
At least two modules kept at temperature to prevent lags

### Monolithic Bed

One monolithic storage tank
Entire system is heated as one unit
System is kept above a minimum temperature at all times
Relies on highly efficient insulation to limit heat loss

### Storage Media

Sodium aluminum hydride
Two phase decomposition from NaAlH4 to NaH
37 kJ/molH2 DH for first phase; 47 kJ/molH2 for second phase
9 kg stored hydrogen

### Heater

Heater is 80% efficient converting stored hydrogen to heat
Maximum heat applied is 9 kW per module or 27 kW per system

### Driving Conditions

Two Driver Profiles:
   Driver 1: Commutes 5 days a week and does not drive on weekends
   Driver 2: Only drives on weekend
Five Different Distances Per Day:
   5.5 miles, 11 miles, 22 miles, 55 miles, and 110 miles
Two Months Total Simulated Duration
   Average out any transients
Overnight Cooldown Cycles Simulated Between Driving Days
   Smart Bed system allowed to cool; Monolithic system constantly heated to stay above 150 C/200 C depending on phase distribution
   Heat loss for both systems ˜300 W (based on advanced insulation)
Tank was refueled as many times as necessary.

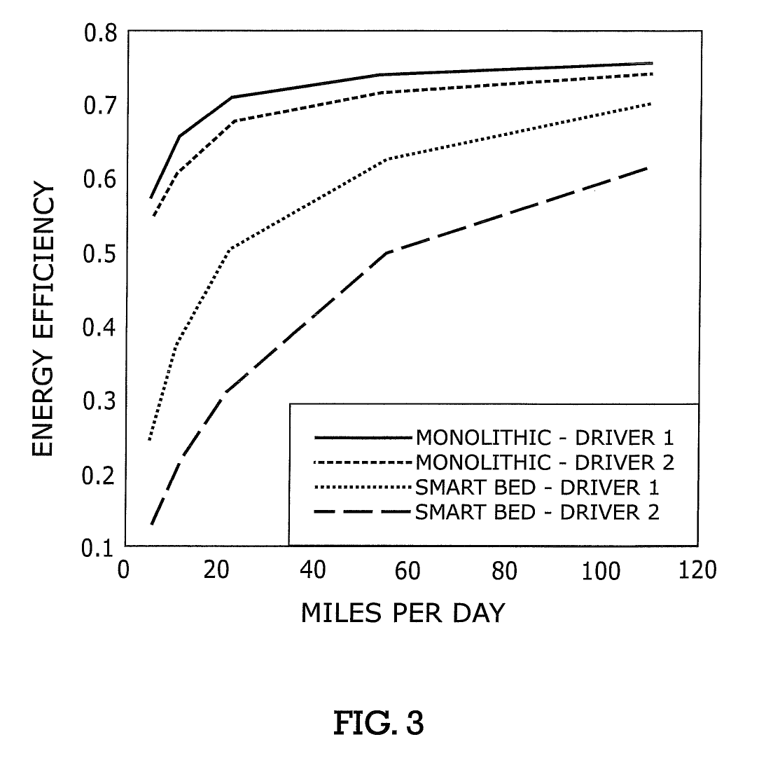

FIG. 3 shows the result of these simulations. Overall system energy efficiency is plotted as a function of driver, storage system configuration, and miles driven per day. Here efficiency is defined as the total mass of hydrogen delivered to the fuel cell divided by the total mass of hydrogen used (heating+delivery). Note that with a heating efficiency of 80% and an average heat of reaction of 40 kJ/mol H2 for sodium alanate, overall energy efficiency would asymptote to 0.83.

The results indicate that the modular system with ‘smart’ control is significantly more efficient than the monolithic system over the entire range of driving conditions. This is especially true when the vehicle is only driven two days per week for short distances such that there is a long time between refueling. In that case, the modular ‘smart’ system is more than four times as efficient.

The coordinated use of multiple modules may be accomplished using a ‘smart’ delivery control scheme. The first part of the approach is to determine how many modules to divide the storage system into. Studies using real world drive cycles indicate that good results can be obtained with 5 to 20 modules. The exact number would depend on the specific storage media thermodynamics and kinetics as well as the vehicle platform. The control logic was developed assuming that between 1 and 3 modules would be active at any one time. So, the modules may be sized so that three acting together can meet the peak demands of the power plant.

The method for sequencing hydrogen flow from the modules is based on the fact that for a fixed temperature the flow rate that a module can produce will be highest when the module is full and will drop to zero as the module is emptied. Increasing temperature can compensate for this reduction in rate, but temperature and heat rate limitations most likely will not allow for complete compensation. So, it is likely that several modules with a range of compositions must be used to meet high flow rates. In addition, it is most energy efficient to heat the minimum amount of storage media that will produce the required flow rate of hydrogen. Given that advanced knowledge of the flow demand is not available and increasing the temperature of a module requires some finite amount of time, this approach must be balanced such that a sudden high flow demand can be accommodated. These criteria and constraints gave birth to the embodiments described hereafter.

Up to three modules may be actively heated and delivering hydrogen at any one time.

Bin-Based Approach: Each of the three active modules represents a flow rate bin (slow, medium, fast). The ‘slow’ module is the one with the least amount of hydrogen while the ‘fast’ module has the most hydrogen.

A pre-determined temperature or range of temperatures may be maintained for each module so that hydrogen is always available. Depending on the storage media, a single temperature might be used, two or more temperatures that increase with decreasing capacity, or a fully variable temperature that increases with decreasing capacity to either maintain a certain rate capability or hydrogen pressure. If a detailed kinetics model of the storage media is available, the temperature may be predetermined based on the rate equation.

Slow Module First: When hydrogen flow is required, use hydrogen from the ‘slow’ module first. If the ‘slow’ module can't meet the flow demand then add hydrogen from the ‘medium’ module and then the ‘fast’ module if required. This way the faster (fuller) modules are available when needed. Flow from each module may be controlled through valve actuation.

To prevent time lags, both the ‘slow’ and ‘medium’ modules may be heated to their respective operating temperatures when any hydrogen flow is required. The ‘fast’ module may be heated when the ‘medium’ module is used to deliver hydrogen.

The status of modules may be changed depending on the available modules with hydrogen in them. Once the ‘slow’ module is empty, the ‘medium’ module becomes ‘slow’, the ‘fast’ module becomes ‘medium’ and a full module becomes ‘fast’ if one is available. If there are only two modules left then there is only a ‘slow’ and ‘medium’ module for desorption control purposes. If all modules are empty but one, this is the ‘slow’ module. However, at this point the storage system is nearly empty and refueling would be advised before the system ‘runs out of gas’.

If the storage system has just been completely filled with hydrogen, then the control system assigns ‘slow’, ‘medium’, and ‘fast’ to three modules even though they are all at the same capacity. This selection may be randomized so that the same modules aren't always used if a driver consistently refuels when the system is not fully empty.

The above description of embodiments of the invention is merely exemplary in nature and, thus, variations thereof are not to be regarded as a departure from the spirit and scope of the invention.

1. A system comprising a modular hydrogen storage system comprising a plurality of discrete modules each constructed and arranged so the hydrogen can be delivered from a discrete module independent of the other modules.

2. A system as set forth in claim 1 wherein each module further comprises a separate heater so the each module may be selective heated independent of the other modules.

3. A system as set forth in claim 1 further comprising a fuel cell operative connected to the modular hydrogen storage system and further comprising a controller designed to receive input regarding the delivery demands of the fuel cell and to selective control the heating of individual modules in response to the delivery demands.

4. A method comprising providing a system comprising a modular hydrogen storage system comprising a plurality of discrete modules each constructed and arranged so that hydrogen can be delivered from a discrete module independent of the other modules, a fuel cell operative connected to the modular hydrogen storage system, starting up the fuel cell comprising heating less than all of the modules to release hydrogen from the heated modules.

5. A method as set forth in claim 4 wherein only one of the modules is heated during the starting up of the fuel cell.

6. A method as set forth in claim 4 wherein at least one module does not include any hydrogen stored therein and one module includes hydrogen stored therein, heating the module with hydrogen stored therein while cooling the module the does not include hydrogen stored therein.

7. A method as set forth in claim 4 further comprising a controller designed to receive input regarding the delivery demands of the fuel cell and to selective control the heating of individual modules in response to the delivery demands, wherein each module has a hydrogen delivery rate as a function of the temperature, pressure, and hydrogen concentration of the module, the controller receiving input regarding fuel cell demand and in response selective heating modules to desorb hydrogen and provide an overall hydrogen delivery rate in responds to fuel cell demand.

8. A method comprising providing a system comprising a modular hydrogen storage system comprising a plurality of discrete modules each constructed and arranged so the hydrogen can be delivered from a discrete module independent of the other modules, a fuel cell operative connected to the modular hydrogen storage system, the plurality of modules including at least a first module, a second module and a third module, heating the first module at a first rate so the hydrogen is available from the first module for delivery to the fuel cell at a first rate, heating the first module at a first rate so the hydrogen is available from the first module for delivery to the fuel cell at a first rate, heating the second module at a second rate so the hydrogen is available from the second module for delivery to the fuel cell at a second rate which is greater than the delivery rate available form the first module, and heating the third module at a third rate so the hydrogen is available from the third module for delivery to the fuel cell at a third rate which is greater than the delivery rate available form the second module.
